(19) United States
(12) Patent Application Publication
(10) Pub. No.: US 2002/0033941 A1
(43) Pub. Date: Mar. 21, 2002

(54) Method and system for aligning an optical fiber delivery system

(76) Inventor: George H. Seward, Arlington, MA (US)

Correspondence Address: CESARI AND MCKENNA, LLP, 88 BLACK FALCON AVENUE, BOSTON, MA, 02210, US

(21) Appl. No.: 09/754,883

(22) Filed: Jan. 5, 2001

Related U.S. Application Data
(60) Provisional application No. 60/219,624, filed on Jul. 21, 2000.

(51) Int. Cl. G01B 11/27

(52) U.S. Cl. 356/153

(57) ABSTRACT

A system and procedure for aligning an information carrying laser beam to an optical fiber. The laser diode is first axially aligned to the end of the fiber within specific angular and spatial tolerances. Practical spatial tolerances in an example are one micro meter in a typical Cartesian x, y, and z coordinate system. The angular tolerance is about one micro radian. The system components include a collimating lens that collimates the laser beam, a strong lens that focuses the collimated laser beam onto the fiber end, and a weak lens placed between the collimated lens and the strong lens that performs the final positioning of the focused beam onto the fiber end. This weak lens provides an optical leverage that allows more than an order of magnitude less tolerance in positioning the weak lens compared to the final position of the laser beam onto the fiber end. The collimation and the position of the elements are determined using known instrumentation, known methods and known mechanical assemblies. The assemblies are finally welded in place and mechanically stabilized by baking.

### CROSS-REFERENCE TO RELATED APPLICATIONS

The present application claims priority from U.S. Provisional Patent Application, entitled Specification of Seward apparatus for delivery of laser-beams, Ser. No.60/219,624, which was filed on Jun. 21, 2000, by George H. Seward, and which application is hereby incorporated herein by reference. It also claims priority from U.S. Provisional Patent Application, entitled Specification of Method for alignment of fiber delivery system and required design specification, Serial No. is not available time of this filing, which was filed on Nov. 13, 2000, by George H. Seward, and which application is hereby incorporated herein by reference.

### BACKGROUND OF THE INVENTION

1. Field of the Invention

The present invention relates to optical fiber information transmitting systems carrying laser beams, and more particularly to alignment of the laser beam to the optical fiber.

2. Background Information

The increase in the demands for ever higher speeds of signal transmission with ever higher signal capacities has hurried the use of lasers and optical fibers for carrying high speed transmissions. These laser optical coupling assemblies are becoming common throughout the world. Certainly the well known limitations of copper lines (higher volume and weight and lower signal speeds and signal capacities) and satellites (high cost and speed limitations of the atmosphere and problems due to weather) for signal transmissions enhance the popularity of laser fiber optics. The laser/fiber transmission system is essentially a laser beam (or several beams) that can be modulated to carry information that is targeted on and coupled to an end of an optical fiber that takes the information carrying beam to the outside world.

An initial problem associated with these assemblies is the alignment of the laser beam and the end of the optical fiber.

The design and manufacturing of the laser optical devices must be cost competitive and easily maintained. But, the alignment accuracy and precision must be preserved. Many such assemblies are ad hoc and there is no recognized strategy that ensures adequate initial alignment and the ability to maintain and/or correct that alignment in field installations.

The specification and tolerance requirements of the industry regarding the physical particulars of the fibers and the lasers involved require alignments accurate to +/−0.1 microns(um). That is the laser beam must be focused on the end of the fiber within this tolerance to ensure reasonable coupling efficiency (loss of 5% or 0.25 dB with a 0.1 um misalignment). An article published at the year 2000 Electronic Components and Technology Conference by Soon Jang of the Newport Corporation discusses the current issues and processes regarding manufacture of laser optical couplers to the needed accuracy and precision, this article is hereby incorporated herein by reference.

There are a number of patents relating to focussing and aligning lasers to the ends of optical fibers. On such patent by Lynch et al. is U.S. Pat. No. 5,077,622 ('622). This patent, which is hereby incorporated herein by reference, discusses the adjustments needed for aligning a polarized laser into the core of an optical fiber. Those adjustments are 1) the beam polarization, 2) the diameter of the beam waist at the target (the end of the fiber), 3) the x and y transverse position of the beam waist with respect to the target, 4) the z axis (the optical axis) position of the beam waist to the target, and 5) the angle of the beam waist in the x and y directions relative to the target. In this patent the laser beam is defined relative to a Gaussian beam as is known in the field, and discussed below. The '622 patent provides for focussing and positioning the beam waist at a desired location with respect to the target fiber end. The physical system uses multiple lenses that move along the optical axis, optical devices that rotate and lenses that move transversely to the optical axis.

The '622 patent also defines “optical leveraging” where the resolution of the associated mechanical devices is relaxed compared to the resolution required for proper alignment of the laser beam to the fiber end. The '622 patent and the present invention are drawn to the alignments 3), 4) and 5) listed above. The required polarization and waist adjustments are well known in the field.

The '622 patent also refers to fiber couplers from the Newport Corp., catalog No. 100 (part numbers L-1015 and L-1015LD) where fiber couplers are shown with adjustment capabilities including lenses that are moved transversely to the optical axis that help position the beam onto the target.

The Newport catalog discloses “optical leverage” by transverse motion of a weak lens, but the calculated values of this optical leverage are limited to about 16 or less. The '622 patent also discloses using large distances between the two focusing elements as optimum.

Neither the '622 patent nor the Newport catalog discuss alignment of the laser beam axis to the fiber axis. Also, neither the '622 patent nor the Newport catalog show practical packaging for fiber optics assemblies. For example, since the fiber connects to the outside world, the strength and ruggedness of the fiber fixation becomes an important factor. The mount must be rugged. Practical focal lengths and optical aberrations, as discussed below, are not discussed in these or other known prior art. But, such issues and their solutions affect practical optical coupler designs.

For the purposes of this invention, an x, y, and z coordinate system is defined where the z direction is along the optical axis, the y direction is the vertical direction normal to the optical base (discussed below) and the z axis, and the x direction is parallel to the optical base plane and normal to both the y and z axes. These axes form the well known three-dimensional Cartesian coordinate systems.

It is an object of the present invention to provide a method and system for accurately and precisely positioning a laser beam onto the end of an optical fiber and accurately and precisely aligning the axis of the laser beam and the axis of the fiber.

### SUMMARY OF THE INVENTION

The objects and other advantages of the present invention are provided by an optical system and method for positioning and alignment of laser beams to optical fibers. Such alignment is described below with respect to the well known optical base which defines a plane parallel to the optical axis.

The present invention includes axially aligning the laser beam to the fiber axis by butt coupling, and storing the xy coordinates of such an alignment with respect to an optical base. Maximizing the output of the fiber is used determine the optimum alignment. Since the fiber end is encased in a ferrule and the laser diode is packaged in a housing, in an example of the invention, the mechanical arrangement accommodates the physical aspects of the components. This axial alignment also establishes the optical or z axis of the system. A collimating lens is mounted allowing adjustments along all three axes which, along with detectors and optical/mechanical devices, discussed below, are used to collimate the laser beam. The collimating measurement and the instruments used are well known by practitioners in the field. The collimating lens is then fixed relative to the optical base, and the collimating detectors and devices are removed. Next a strong lens is placed between the collimating lens and the target fiber end and is positioned in the x and y directions and the ferrule in the z direction until a maximum output of the fiber is found. The strong lens is fixed in place. Next a weak lens is placed between the collimating lens and the strong lens. Again the optimum position is found by maximizing the energy output of the fiber by moving the weak lens in the x, y direction and the ferrule in the z direction. The ferrule is fixed in place, and the entire assembly is stabilized. The weak lens is then moved in the x and y directions for a maximum fiber output, then the weak lens is fixed in place. In a preferred embodiment the fixing in place may be by welding whereupon the assembly may be baked to stress relief the mechanical connections and thereby stabilize the assembly.

The inventive system and method is based upon the coaxial nature of the laser diode and the fiber encased ferrule. The method permits, in an example, the assembly of fiber-optic couplers with relaxed tolerances by employing transverse positioning of a weak converging lens after optimization of a strong converging lens. The relaxed spatial tolerance for this weak lens is at least 1 um which is at least 10 times the acceptable radial error of 0.1 um for the focused beam at the fiber. The method relies upon achieving angular tolerances at 1 mrad (milli-radians) in value, and transverse errors of the collimated beam to the axis of the fiber of less than 50 um. This spatial collimation error is 500 times the acceptable radial error of 0.1 um for the focused beam at the fiber. It is desirable to reduce this error to only 10 um if possible because the track length will be less. This spatial collimation error is 100 times the acceptable error of 0.1 um for the focused beam at the fiber.

An example of the system and method has been presented for the assembly of a fiber optic coupler. The invention relaxes the tolerances of fixation by employing a weak lens in the optical system. The fixation of the weak lens is performed last in the assembly and facilitates the alignment by the relaxed tolerances associated with moving the weak lens, due to the optical leverage, to minimize the alignment errors. The fabrication and fixation tolerances of the fiber ferrule specify a lower limit on the focal lengths of the optical system. Observing these dependent parameters permits an assembly procedure which requires only 1 um of tolerance of the weak lens positioning, which is significantly superior to the 0.1 um required in present day methods.

An alternative method to the above collimation and focusing is presented. The position of the collimating lens in the x, y, and z directions, the position of the strong lens in the x and y directions, and position of the fiber along the z direction can be manipulated by multidimensional search algorithm which finds the local maximum for coupling. At his point the beam is centered on the axis of fiber in both space and angle. The position of the weak lens in the x any y directions and position of the fiber along the z direction is then optimized for maximum coupling efficiency.

### BRIEF DESCRIPTION OF THE DRAWINGS

The invention description below refers to the accompanying drawings, of which:

FIG. I is a ray tracing drawing showing some basic components of the invention;

FIG. 2 is a more detailed drawing of a practical implementation of the components of FIG. 1;

FIG. 3A, B, and C are ray tracings showing wavefront tilt error created by alignment errors;

FIG. 4 is a composite drawing of a lens gripper; and

FIG. 5 shows the tools used for collimating the laser beam.

### DETAILED DESCRIPTION OF AN ILLUSTRATIVE EMBODIMENT

With respect to FIG. 1, an assembly with leverage of forty was built according to the present invention. The fiber 102 encased in a ferrule 104 was aligned to the axis of the laser diode 106 using microbench components from Linos. The strong lens 108 is an aspheric lens of 5 mm in focal length (Thorlabs C430TM-B or Geltech 350430). The weak lens 110 was a plano-convex lens of 200 mm in focal length (Linos 312325). The strong and weak lenses were mounted in high precision translating lens mounts. These mounts employ fine pitch adjustment screws 112, 114 at 4 threads per mm. The collimating lens 116 is a compound lens positioned by the tolerance of Microbench components. The specific elements of this compound lens are a collimated laser diode package, and a two element beam expander. An additional weak lens 111 of −200 mm in focal length (Linos part number 314334) is added for: fine adjustment of z focus by translation along the z-axis, and for compensation of spherical aberrations created by the transversely moving weak lens 110. The alignment is sensitive to the alignment of the collimated beam to the axis of the fiber. Precision mounting of the laser is required. For example, calculations reveal that the collimated beam must be centered on the optical axis to within 0.01 times focal length of the aspheric lens 108 to insure a wavefront tilt below 1/10 of one wave-length at the fiber. For the 5 mm focal length, this corresponds to 50 microns. This magnitude of tolerance can be achieved with fixtures for the laser diode and the fiber. A smaller focal length will reduce the tolerances proportionally, and the assembly will become more difficult to align.

A definition of axes is beneficial as a starting point. The z-axis 120 is the optical axis. The x-axis 122 is parallel to the plane of the optical base to which the components are mounted by a variety of hardware. The y-axis 124 is perpendicular to the optical base. The angular orientations are pitch, yaw, and roll. The pitch is rotation about the x-axis. The yaw is rotation about the y-axis. The roll is rotation about the z-axis.

In the alignment procedure, the x, y, and z positions are determined by one or more automated grippers. A gripper, a well known device which securely holds an optical lens, is positioned by three translation stages, one along each axis of x, y, and z.

The pitch and yaw of all optical elements are determined by mounting hardware. The optical elements all are mounted with their planar faces as perpendicular to the optical axis as possible. The angular error in pitch and yaw should not exceed 1 mrad. Such an angular tolerance may be achieved with known devices.

Establishment of Optical Axis

The laser diode and fiber are aligned to the optical axis by the gripper of an automated assembly device. The gripper is a claw with planar faces that mate to planar faces of the mounting hardware. In this process, both the laser diode and the fiber components must be mounted in hardware that orients them as square to the gripper. Thus, when the gripper grabs the component, the optical axis of that component is parallel to one translation axis of the gripper (the z-axis). Such a translation axis can be straight to within 0.75 um over 1.6″with 25 nm of longitudinal resolution (as specified in the Newport catalog 2000 p2-9).

The y-positions of the laser diode and fiber are determined by tolerance of the mounting hardware. In the preferred embodiment, this tolerance is 50 um. In systems with shorter focal lengths, a smaller tolerance is required. In general, this tolerance scales with focal length of the strong converging lens 108.

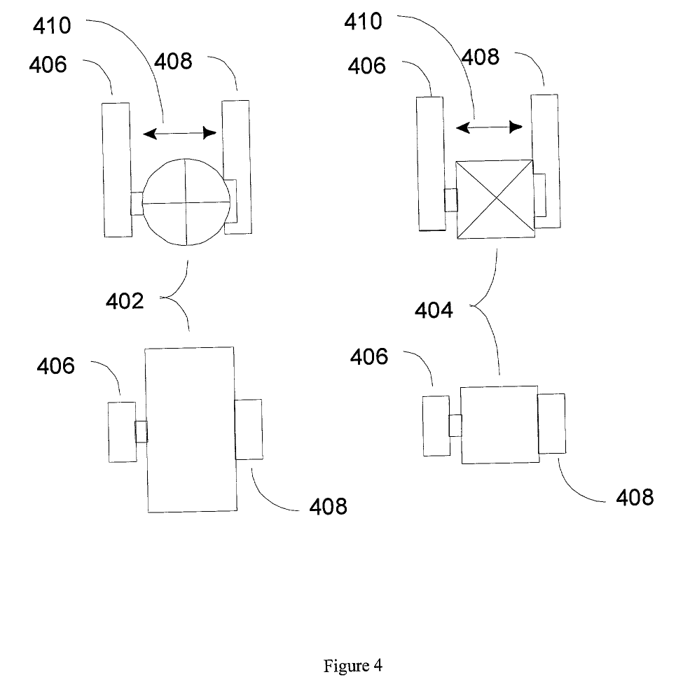

The x-position of the fiber is determined by butt coupling to the diode laser. Two grippers are required for this procedure. The first gripper grabs the base of the laser diode. It is mounted to the optical base at this time, and it is operational. The grasp of the gripper aligns the axis of the diode to the z-axis of its stage within 1 mrad. The fiber is grabbed by a second gripper with similar tolerances. The fiber is positioned in x, y, and z for best coupling of light from the diode. The mounting base of the diode must permit sufficient clearance in the y-direction for the mounting barrel of the fiber, which is called a ferrule. At the optimum position for butt coupling, the x-y-position of the optical axis is set. This x-y-position is used for fiber placement. When the fiber is eventually fixed in place, the fixation tolerance is 1 um along x, y, and z. A gripper as known in the art is shown in FIG. 4. The gripper has two claws 406 and 408 that grasps either a cylinder 402 or a block 404. One gripper claw 408 has a slot for angular alignment of the cylinder. The other gripper claw 406 has a post that pushes the cylinder into the slot. The gripper claws travel along the double arrows 410. The post of 406 ensures a parallel orientation of the block face with the face of the slotted gripper claw 408.

Method of Collimation

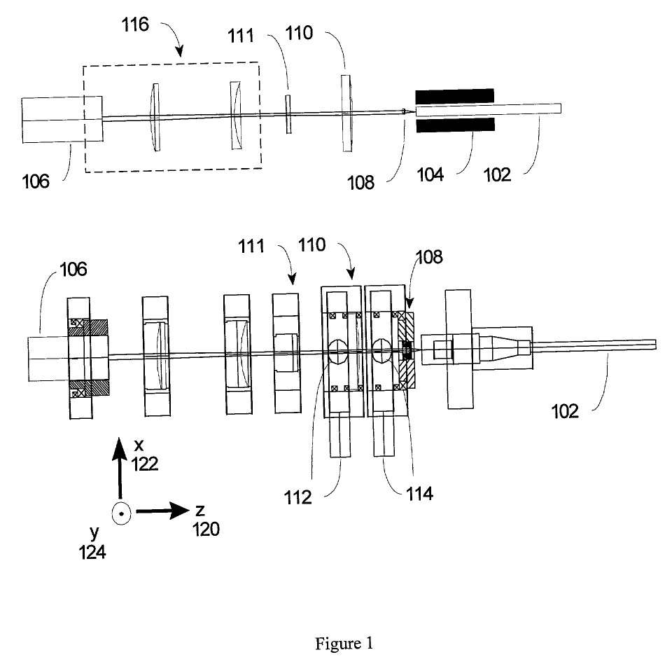

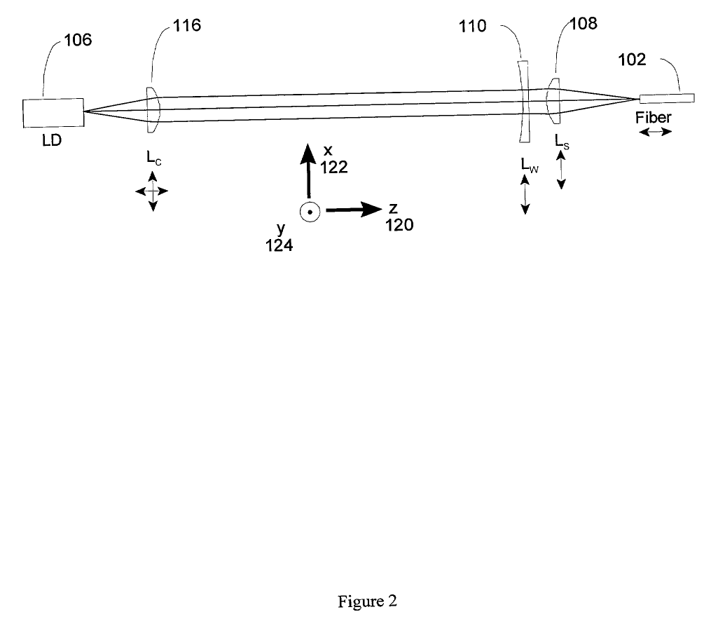

Referring to FIG. 2, collimation is performed by positioning of collimating lens L_{c} in x, y, and z. Pitch, yaw, and roll are determined by the grasp of the gripper. The collimation of the beam is quantified by two metrics: pitch-yaw, and wavefront error.

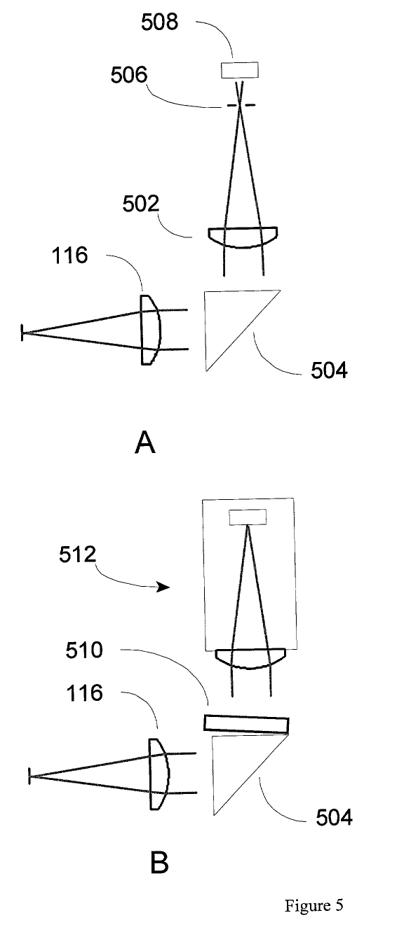

A spatial filter of FIG. 5A quantifies the pitch-yaw within 1 mrad. This spatial filter employs the following optical components: a plano-convex lens 502, a right-angle prism 504, a pinhole 506, and a detector 508. The aperture of the pinhole is equal to 0.001 times the focal length of the plano-convex lens. Actually the strong lens, L_{S}, is good choice for this lens. Collimated light is focused by the lens, folded by the prism, and passed through the pinhole. The mounting hardware provides the 1 mrad of alignment to the gripper. The position of the pinhole is aligned for maximum transmission of an incoming beam that is parallel to the z-axis of the gripper. The pinhole can be also created by ablation by a laser beam that is aligned to the axis of the gripper within 1 mrad. The laser diode beam does not have to be precisely centered on the lens. This device quantifies only the angle of the beam. The proper orientation of the beam is found by scanning the collimating lens through a specified range of x-y-positions. When the beam passes though the spatial filter, the beam is aligned within 1 mrad of the optical axis.

The wavefront error is quantified by either a shear plate interferometer or a collimation tester. The basic design of a shear plate is available in the Melles Griot Catalog. A collimation tester from Thorlabs can also be used. The wavefront must be flat as specified by this measurement. The wavefront's direction is not important during this alignment.

The above two metrics are performed in an iterative manner. First the pitch-yaw is optimized, and then the flatness is optimized. After several iterations, the beam is both straight and collimated.

A design for a shear plate is shown in FIG. 5B. It employs a similar folding prism 504 to the spatial filter in Figure SA. The shearing interferometer is created by wedge of air created by the tilted shear plate 510. The shearing interferometer creates an interference pattern that resembles the curvature of the wavefront. This interferomter is imaged by a CCD (charge coupled device) camera 512. If the wavefront is flat, the fringes of the interferometer are parallel to the tilt axis of the shear plate. If the beam is converging of diverging, then the fringes are tilted with respect to the tilt axis of the shear plate.

Angle of Wavefront at Fiber

A Gaussian beam has two important properties when focused at the entrance to a single mode fiber: the beam diameter and the wavefront curvature. These features are described.

The Gaussian beam has an irradiance profile described by

$$I = \frac{8 {P}_{0}}{{πφ}^{2}} exp ( \frac{- 8 {r}^{2}}{{φ}^{2}} ) ,$$

in which, P₀ is the optical power of the beam, φ is the beam diameter, and r is transverse radial position from beam's axis of propagation. The beam diameter is expressed as

φ²=φ₀²+β²(z−z₀)²,

in which φ₀ is diameter of the beam waist, β is the full angle of beam divergence for the beam diameter, z is the position along the axis of propagation, and z₀ is the position of the beam waist along z. The beam waist and beam divergence diameter are related by the following space-angle product:

$${φ}_{0} β = \frac{4}{π} λ = \frac{λ}{{π}_{4}} ,$$

in which λ is the wavelength of the electromagnetic wave of the traveling laser beam, and π₄ is a convenient abbreviation for π/4.

The wavefront of the traveling beam refers to a two-dimensional surface that corresponds to the position of the maximum electric field within a single cycle of the electromagnetic wave. For a circularly symmetric beam profile, the wavefront is coincident with a sphere whose radius changes throughout the axis of propagation. The radius of this wavefront is described as

$$R = \frac{{φ}^{2}}{{β}^{2} ( z - {z}_{0} )} .$$

At the beam waist, the radius is infinite. This corresponds to a flat wavefront. As the distance to from waist increases, the radius reaches a minimum magnitude. This minimum occurs at the Rayleigh distance. It is expressed as

$${z}_{R} = \frac{{π}_{4} {φ}_{0}^{2}}{λ} .$$

The corresponding radius of the wavefront is twice the Rayleigh distance.

A flat wavefront at the fiber is extremely important at the fiber input, because the wavefront of the single mode of the fiber is also flat. The wavefront should also be normal to the axis of the fiber.

The wavefront error due to a tilt at the fiber is approximated as

λ_{ET}=φ_{M}θ_{W},

in which φ_{M} is the diameter of the Gaussian mode of the fiber, and θ_{W} is the angle of the wavefront normal with respect to the axis of the fiber. Typically, the diameter of a single mode field pattern is seven times that of the wavelength. The actual pattern extends beyond this diameter, thus an effective diameter of 10 times the wavelength is a fair approximation.

φ_{M}≈10λ.

The resulting wavefront error due to tilt becomes

θ_{ET}=10θ_{W}λ.

A wavefront error of less than one-tenth of one-wavelength is considered perfect for all practical applications. Such an error in wavefront tilt requires that

θ_{W}≦10mrad.

This condition is achieved by proper selection of focusing optics as based upon the spatial and angular tolerances of the incoming beam.

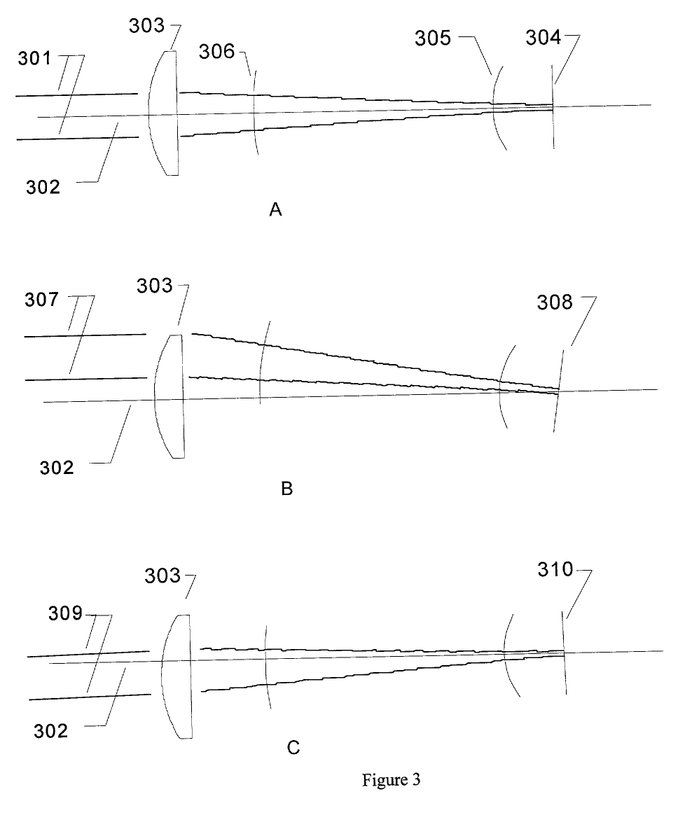

A properly focused Gaussian beam is displayed in FIG. 3. The incident Gaussian beam 301 is portrayed by the propagation of its outer edges of its beam diameter. The optical axis 302 matches that of the fiber, not shown. The converging lens 303 focuses the beam to a flat wavefront 304 at its waist. The flat wavefront 304 is represented as a straight line. At the Rayleigh distance, the wavefront is represented by an arc 305. The radius of this arc is proportionally correct in this figure for beam waist diameter of 8 um and wavelength of 0.8 um. Near the lens, a wavefront 306 has a radius centered on the beam waist.

In FIG. 3B the incident beam 307 is off-center. The transverse error in the position of the beam creates a tilt of the wavefront 308 at the fiber. This tilt due to the radial collimation error is

$${θ}_{RCE} = \frac{- {r}_{CE}}{f} ,$$

in which r_{CE} is the radial distance of collimation error, and ƒ is the focal length of the lens.

In part C of FIG. 3, the incident beam 309 is off-axis in angle. This angle of collimation error creates a tilt of the wavefront 310 at the fiber. This tilt created by the angular collimation error is equal to the angle of collimation error

θ_{ACE}=θ_{CE},

in which θ_{CE} is the angle of collimation error. The total error in angle of the wavefront created by collimation error is

$${θ}_{WCE} = \frac{- {r}_{CE}}{f} + {θ}_{CE} .$$

From the above equation, it is easily observed that the wavefront angle is zero when r_{CE}=θ_{CE}ƒ. In this condition the axis of the beam travels through the front focal point of the lens. Subsequently, the lens focuses the beam to a point with a radial position equal to r_{CE}. The wavefront error at this off-axis focal point is zero.

The condition of the previous paragraph is an optimum solution, but it is not easily achieved. Both the collimating lens and the strong lens must be manipulated in the x, y, and z directions as part of search algorithm that drives the system towards local maximum (the z direction of the strong lens can be managed motion of the fiber along z). Such a search algorithm is not easily managed, because an improvement in the spatial alignment can be offset by degradation of the angular alignment. This method does however eliminate the need for collimating the beam within a specific tolerance.

A more practical solution is selection of the focal length based the expected radial error. By increasing the focal length, the angular error due to the radial collimation error is reduced to an acceptable size.

Error in the Collimated Beam

If the beam is aligned within 1 mrad of the optical axis, then the transverse error resulting at the collimating lens is equal to 1 mrad times the focal length of the collimating lens. Thus, for a 2 mm focal length, the centering error of the beam with respect to the optical axis is 2 um at the collimating lens. After traveling to the next lens, the error increases by 1 mrad times that distance. Thus, the error in centering of the beam at the strong lens is equal to 1 mrad times the distance from the laser to the strong lens. For a 10 mm distance this creates a 10 um error. This is much larger than the fixation error of the strong lens. Thus, the error in centering the beam at the strong lens is dominated by the angular error in collimation.

The angle of collimation error is specified by θ_{CE} The radial distance of collimation error r_{CE} is expressed as

r_{CE}≈r_{LE}+d_{LS}θ_{CE},

in which: r_{LE} is radial laser error with respect to the axis of the fiber, and d_{LS} is longitudinal distance from the laser to the strong focusing lens. The resulting angular error at the fiber is this transverse error at the strong lens divided by the focal length of the strong lens. Thus, the total error in angle of the wavefront created by collimation error is expressed as mathematically as

$${θ}_{WCE} = \frac{{r}_{LE}}{{f}_{S}} + \frac{{d}_{LS} {θ}_{CE}}{{f}_{S}} + {θ}_{CE} .$$

The above equation contains three components: the pure radial error, the longitudinal error, and the pure angular error. The pure angular error θ_{CE} is easily managed. The pure radial error presents much more difficult challenges than the other two components. An angular error of 1 mrad is easily achieved by positioning the collimating lens within 0.001 times its focal length. Thus,

θ_{CE}<1 mrad.

If the longitudinal error

$$\frac{{d}_{LS} {θ}_{CE}}{{f}_{S}}$$

is kept within 10 mrad, then

d_{LS}≦10ƒₛ.

Thus, the distance from the laser to the strong lens must be less than 10 times the focal length of the strong lens. If the focal length of the strong lens is 1.5 mm, then there is 15 mm available for the weak and collimating lenses. This is plenty of room. Therefore, this condition is not critical.

If the radial angular error

$$\frac{{r}_{LE}}{{f}_{S}}$$

is kept within 10 mrad, then

ƒ≧100r_{LE}.

This condition specifies a minimum focal length for the fiber. If the focal length of the strong lens is 1.5 mm, then a 15 um tolerance results. It corresponds to spatial collimation error of 150 times the allowable spatial error of 0.1 um for the focused beam at the fiber. This is not easily achieved by assembly tolerances. It is desirable to reduce this error to only 10 um if possible because ∥ₛ and the track length become shorter. This spatial collimation error is 100 times the acceptable error of 0.1 um for the focused beam at the fiber. The y-position of the fiber must be properly aligned and then fixed in place. If the focal length is 5 mm, then only 50 um is required. This can be achieved by simply placing the ferrule in contact with optical base. The x-position is adjusted by the weld clip.

Optical Leverage Created by Weak Lens

The transverse motion of the weak lens provides optical leverage on the transverse position of the beam at the fiber. This leverage is equal to the ratio of the focal lengths.

$$L = \frac{{f}_{W}}{{f}_{S}} ,$$

in which, ƒ_{W}, and ƒ_{S} are the focal lengths of the weak and strong lenses respectively. This leverage permits positioning of the beam at the fiber to within 0.1 urn while employing much larger motions by the weak lens. This leverage must be at least 10× to achieve assembly tolerances of 1 um as the minimum. This method of alignment permits accurate fixation with tolerances of 1 um or greater.

Actually, the aberrations created by L_{W} are reduced as L_{W} becomes larger in focal length. For example, while using an aspheric lens of 5 mm in focal length for the strong lens, various lenses were evaluated for a 10 um shift of the focused beam. The evaluation was done in an optical design program known as OSLO, which is available from Sinclair Optics of Fariport, N.Y. However, other such programs are known in the field and the measurements can be done experimentally. As the focal length of L_{w} became longer, the required shift by L_{w} became larger but the aberrations at the spot became smaller. The following table displays results of this study.

| | leverage created | | | magnitude |
|---|---|---|---|---|
| f_{W} | with f_{S} at 5 mm | shift by L_{W} | shift at fiber | of aberrations |
| 50 mm | 10 | 100 um | 10 um | 0.24 um |
| 100 mm | 20 | 200 um | 10 um | 0.12 um |
| 200 mm | 40 | 400 um | 10 um | 0.04 um |
| 400 mm | 80 | 800 um | 10 um | 0.02 um |

At a leverage of 10, the aberrations are 0.24 urn. This is a significant error for fiber coupling that requires 0.1 urn of accuracy. At a leverage of 20, the aberrations are reduced to 0.12 urn. At a leverage of 40, they are at 0.04 um which is very acceptable. All of these aforementioned aberrations were spherical. At a leverage of 80, the aberrations are at 0.02 urn, and they were mostly coma.

A leverage of 40 is sufficient for fiber delivery with this particular 5 mm aspheric lens as the strong lens. Furthermore, the shift by the weak lens can be as large as 2.0 mm while maintaining geometric aberrations below 0.1 um. The corresponding shift at the fiber is 50 urn. Such an off-axis position corresponds to a wavefront angle of 10 mrad. The two errors, one spatial and the other angular, are both within acceptable levels. Thus, the leverage of 40 is optimum.

A prototype with leverage of 40 was assembled by this alignment concept with a few exceptions as displayed in FIG. 1. -The alignment was very sensitive to the alignment of the collimated beam to the axis of the fiber. Precision mounting by of the laser was required. The tolerance of the laser diode fixture provided Linos was sufficient. The tolerance of a laser diode fixture by Thorlabs was not. The errors induced by the Thorlabs mount created significant losses. Calculations revealed that the collimated beam must be centered on the optical axis to within 0.01 times ƒ_{S} to insure a wavefront tilt below 1/10 of one wavelength at the fiber. For the 5 mm focal length, this corresponds to 50 microns. This magnitude of tolerance can be achieved with fixtures for the laser diode and the fiber. A smaller focal length will reduce the tolerances proportionally, and the assembly will become more difficult.

Method of Mounting Laser Diode

The laser diode must be mounted to a base plate that can be grabbed by the gripper. The grasp of the gripper aligns the pitch and yaw of the laser base plate. The laser is mounted to the base within 1 mrad of yaw from the proper axis. A vision system can confirm this alignment.

Mounting of the Lenses

A lens is mounted inside a lens barrel. The grasp of the gripper aligns the pitch-yaw of the lens barrel. The gripper positions the lens barrel in space. A second gripper places a right-angle bracket in contact with the lens barrel and the optical base. The right-angle bracket is then welded to both the barrel and the optical base. In the case of the weak and strong lenses, a single bracket can be welded to the base prior to alignment of both lenses. Subsequently, the strong lens is mounted to one side the bracket, and then the weak lens is mounted to the other side.

Mounting of the Fiber Ferrule

The fiber ferrule is mounted to the optical base by a weld clip. The tolerance of this clip should be sufficient for achieving less than 50 um of error in the y-axis. The error in the x and z directions are determined by the gripper. The fixation tolerance is less than 1 um.

Alignment Procedure

Step 1: Grab laser diode base with gripper G_{LD}.

Step 2: Mount laser diode base to optical base.

Step 3: Align the axis of fiber to the axis of the laser diode by optimization of butt coupling. Use gripper G_{F} to grab fiber without clip in place. Store x-y-position for future placement of fiber along optical axis

Step 4: Use gripper G_{L} to position L_{C} in its nominal position.

Step 5: Align output of L_{C} to the optical axis by motion of L_{C} in x, y, and z. Use shear plate interferometer for adjustment of wavefront flatness by translation along z. Use spatial filter for adjustment of collimation angle by translation along x and y. Use G_{C} to grip these inspection tools.

Step 6: Use gripper G_{C} to position bracket against L_{C}.

Step 7: Weld bracket to the optical base.

Step 8: Weld bracket to the lens barrel.

Step 9: Install single bracket for both strong and weak lens. Use Gripper G_{C} to position. Weld in place.

Step 10: Use gripper G_{F} to position fiber along the x-axis of the optical axis as previously defined. The weld clip is on the fiber at this time. Position fiber ferrule against the optical base. The x-y-position of the fiber is now set.

Step 11: Use gripper G_{L} to place strong lens against the back face of the right-angle bracket.

Step 12: Maximize delivery into the fiber by x-y motion of the strong lens and z-motion of the fiber.

Step 13: Weld strong lens in place within 1 um.

Step 14: Use gripper G_{L} to place weak lens against the other face of the right-angle bracket.

Step 15: Maximize delivery into the fiber by x-y motion of the weak lens and z-motion of the fiber.

Step 16: Weld fiber in place within 1 um.

Step 17: Stabilize welds as necessary. Stress relief by baking if necessary.

Step 18: Optimize x-y of the weak lens

Step 19: Weld weak lens in place within 1 um.

Step 20: End of alignment procedure.

The specific choice of focal lengths is essential to the relaxation of assembly tolerances.

There is a minimum for the focal length of the strong lens based upon the transverse error of the laser

ƒ_{S}>100r_{LE}.

At 5 mm for ƒ_{S}, the transverse error at the fiber is reasonable. At smaller values of ƒ_{S}, the y-position of the fiber must be aligned and then fixed in place—this can be a difficult operation.

Furthermore, the fiber is coupled to the outside world. Therefore, maximizing the strength of the fiber's fixation is paramount. Avoiding the adjustment of the fiber is beneficial. This sets a lower limit on the radial error of the laser. Alignment of the fiber by accommodation of the mechanical tolerances specified for assembling the fixtures of the diode and the fiber is an unobvious advantage of using the 5 mm focal length for the strong lens.

There is also an optimum value for the weak lens, At 5 mm in focal length for the strong lens, there is an optimum range in focal length of the weak lens. At 100 mm, the aberrations are not minimized. At 200 mm, the aberrations are sufficiently small, and thus optical leverage of 40 is an optimum in a preferred embodiment.

What is claimed is:

1. A method for aligning the optical elements which couples and focuses a diode laser beam from a laser diode into an optical fiber, the method comprising the steps of:
determining a first set of angular and spatial tolerances applicable to the focused laser beam entering the fiber,
determining a second set of angular and spatial tolerances for collimating the laser beam by placing a lens in the laser diode beam such that a collimated beam is produced and aligned to the axis of the fiber within the second set of angular and spatial tolerances,
determining a third set of angular and spatial tolerances for focusing the laser beam onto the axis of the optical fiber within the third spatial tolerance by placing a strong lens within the collimated beam within the third spatial tolerance, and
steering the laser beam onto the axis of the optical fiber within first spatial tolerance by placing a weak lens within the collimated beam within the third spatial tolerance.

2. The method as defined in claim 1 wherein the third spatial tolerance is at least ten times larger than the first spatial tolerance.

3. The method as defined in claim 2 where the first spatial tolerance is 0.1 micron and the third spatial tolerance is 1.0 microns.

4. The method as defined in claim 2 where the first spatial tolerance is 0.1 micron and the second spatial tolerance is 10 microns.

5. The method as defined in claim 1 wherein the second spatial tolerance is at least one hundred times larger than the first spatial tolerance.

6. The method as defined in claim 1 further comprising the steps of:
maximizing the energy output of the fiber to determine when the positioning, collimation, and focusing is optimum.

7. The method as defined in claim 1 wherein the focal length of the strong lens is about 5 mm in conjunction with an axial tolerance of about 50 micrometers for the laser beam incident upon the strong lens with respect to the optical fiber.

8. The method as defined in claim 1 further comprising the steps of:
placing a collimating lens axially aligned in parallel with the axis of the laser diode, wherein the collimating lens performs the step of collimating the laser beam in parallel with the axis of the laser diode and the axis of fiber, and,
prior to placing the weak lens,
maximizing the output from the fiber by moving the strong lens in a direction normal to the optical axis and by moving the fiber end along the optical axis, and after placing the weak lens, maximizing the output of the fiber by moving the weak lens in a direction normal to the optical axis and by moving the fiber end along the optical axis.

9. A system for aligning the optical elements which couples and focuses a diode laser beam from a laser diode into an optical fiber, the system comprising:
a first set of angular and spatial tolerances applicable to the laser beam entering the fiber,
means for collimating the laser beam to the axis of the fiber within the second spatial and angular tolerance,
a second set of angular and spatial tolerances for positioning the collimated laser beam to the axis of the fiber,
a third set of angular and spatial tolerances and a strong lens placed within the collimated beam that focuses the collimated laser beam onto the axis of the optical fiber within the third spatial tolerance, and
a weak lens placed, within the third spatial tolerance, within the collimated beam, that steers the collimated laser beam onto the axis of the optical fiber within the first spatial tolerance.

10. The system as defined in claim 9 wherein the third spatial tolerance is at least ten times larger than the first spatial tolerance.

11. The method as defined in claim 10 where the first spatial tolerance is 0.1 micron and the third spatial tolerance is 1.0 microns.

12. The system as defined in claim 10 where the first spatial tolerance is 0.1 micron and the second spatial tolerance is 10 microns.

13. The system as defined in claim 9 wherein the second spatial tolerance is at least one hundred times larger than the first spatial tolerance.

14. The system as defined in claim 9 further comprising:
means for maximizing the energy output of the fiber to determine when the positioning, collimation, and focusing is optimum.

15. The system as defined in claim 9 wherein the focal length of the strong lens is about 5 mm in conjunction with an axial tolerance of about 50 micrometers for the laser beam incident upon the strong lens with respect to the optical fiber.

16. The system as defined in claim 9 further comprising:
a collimating lens placed axially aligned in parallel with the axis of the laser diode that collimates the laser beam in parallel with the axis of the laser diode and the axis of the fiber, and,
with the weak lens removed, means for measuring and maximizing the output from the fiber by moving the strong lens in a direction normal to the optical axis and by moving the fiber end along the optical axis, and
after replacing the weak lens, means for measuring and maximizing the output of the fiber by moving the weak lens in a direction normal to the optical axis and by moving the fiber end along the optical axis.

17. A method for aligning the optical elements which couples and focuses a diode laser beam from a laser diode into an optical fiber, the method comprising the steps of:
determining a first set of angular and spatial tolerances applicable to the focused laser beam entering the fiber,
collimating and focusing the laser beam to be aligned with and onto the axis of the optical fiber within a third set of angular and spatial tolerances by placing a collimating and a strong lens in the laser beam, and
steering the laser beam onto the axis of the optical fiber within first spatial tolerance by placing a weak lens within the collimated beam within the third spatial tolerance
